(19) United States
(12) Patent Application Publication
(10) Pub. No.: US 2010/0162055 A1
(43) Pub. Date: Jun. 24, 2010

(54) MEMORY SYSTEM, TRANSFER CONTROLLER, AND MEMORY CONTROL METHOD

(75) Inventors: Takeo Morita, Kanagawa (JP); Akira Aoki, Kanagawa (JP); Tetsuya Murakami, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: KABUSHIKI KAISHA TOSHIBA, Tokyo (JP)

(21) Appl. No.: 12/558,718

(22) Filed: Sep. 14, 2009

(30) Foreign Application Priority Data
Dec. 24, 2008 (JP) 2008-328465

(51) Int. Cl. G06F 11/00; G06F 12/00

(52) U.S. Cl. 714/704; 714/E11.004; 711/170

(57) ABSTRACT

A memory system includes a nonvolatile memory, a volatile buffer memory connected to the nonvolatile memory, an error counting unit that detects, for each of divided areas formed by dividing a storage area of the volatile buffer memory into a plurality of areas, a parity error in inputting data to and outputting data from the divided areas and counts a number of times of accumulation of the parity error, and a control unit that sets the divided area, in which the number of times of accumulation of the parity error counted by the error counting unit exceeds a predetermined number of times, in a disabled state.

### CROSS-REFERENCE TO RELATED APPLICATIONS

This application is based upon and claims the benefit of priority from the prior Japanese Patent Application No. 2008-328465, filed on Dec. 24, 2008; the entire contents of which are incorporated herein by reference.

### BACKGROUND OF THE INVENTION

1. Field of the Invention

The present invention relates to a memory system, a transfer controller, and a memory control method.

2. Description of the Related Art

As a memory system used in a computer system, a solid state drive (SSD) mounted with a nonvolatile semiconductor memory such as a NAND flash memory (hereinafter, “NAND memory”) attracts attention. The memory system such as the SSD has advantages such as high speed and light weight compared with a magnetic disk device.

In the NAND memory, an error rate rises as the number of times of rewriting increases. Therefore, in the SSD, an error correcting code circuit is mounted in a NAND memory chip or a transfer controller that controls data transfer between the NAND memory and a host apparatus such as a personal computer (see, for example, Japanese Patent Application Laid-Open No. 2008-041171).

The SSD includes a nonvolatile memory such as a dynamic random access memory (DRAM) used as a buffer memory or a cache memory for performing data transfer between the NAND memory and the host apparatus such as the personal computer. In recent years, it has become evident that, when a DRAM is connected to the outside of a transfer controller, an error occurs in access to the DRAM because of the influence of noise and the like. In the SSD in the past, the error that occurs in the access to the DRAM is corrected by an ECC circuit mounted on the transfer controller, a driver of the host apparatus, or the like. The operation for the error correction is a cause of deterioration in data transfer efficiency of the SSD. Therefore, there is a demand for a technology for reducing a frequency of occurrence of an error during the access to the DRAM.

### BRIEF SUMMARY OF THE INVENTION

A memory system according to an embodiment of the present invention comprises:

a nonvolatile memory;

a volatile buffer memory connected to the nonvolatile memory;

an error counting unit that detects, for each of divided areas formed by dividing a storage area of the volatile buffer memory into a plurality of areas, a parity error in inputting data to and outputting data from the divided areas and counts a number of times of accumulation of the parity error; and

a control unit that sets the divided area, in which the number of times of accumulation of the parity error counted by the error counting unit exceeds a predetermined number of times, in a disabled state.

A transfer controller that controls a nonvolatile memory and a volatile buffer memory connected to the nonvolatile memory according to an embodiment of the present invention comprises:

an error counting unit that detects, for each of divided areas formed by dividing a storage area of the volatile buffer memory into a plurality of areas, a parity error in inputting data to and outputting data from the divided areas and counts a number of times of accumulation of the parity error; and

a control unit that sets the divided area, in which the number of times of accumulation of the parity error counted by the error counting unit exceeds a predetermined number of times, in a disabled state.

A memory control method for controlling a nonvolatile memory and a volatile buffer memory connected to the nonvolatile memory according to an embodiment of the present invention comprises:

dividing a storage area of the volatile buffer memory into a plurality of areas;

detecting a parity error in inputting data to and outputting data from the divided areas;

counting a number of times of accumulation of the parity error; and

setting the divided area, in which the number of times of accumulation of the parity error exceeds a predetermined number of times, in a disabled state.

### BRIEF DESCRIPTION OF THE DRAWINGS

FIG. 1 is a diagram for explaining a configuration of an SSD;

FIG. 2 is a diagram for explaining a data flow;

FIG. 3 is a diagram for explaining a data flow;

FIG. 4 is a diagram for explaining a functional configuration of a DRAM controller according to a first embodiment of the present invention;

FIG. 5 is a diagram for explaining a method of managing a parity calculation result;

FIG. 6 is a flowchart for explaining the operation of the DRAM controller according to the first embodiment;

FIG. 7 is a flowchart for explaining the operation of the DRAM controller according to the first embodiment;

FIG. 8 is a flowchart for explaining the operation of the DRAM controller according to the first embodiment;

FIG. 9 is a diagram for explaining a functional configuration of a DRAM controller according to a second embodiment of the present invention;

FIG. 10 is a diagram for explaining a change of a capacity of a DRAM;

FIG. 11 is a diagram for explaining a functional configuration of a DRAM controller according to a third embodiment of the present invention;

FIG. 12 is a diagram for schematically explaining the operation according to the third embodiment;

FIG. 13 is a diagram for explaining a functional configuration of a DRAM controller according to a fourth embodiment of the present invention;

FIG. 14 is a diagram for schematically explaining the operation according to the fourth embodiment;

FIG. 15 is a diagram for explaining a functional configuration of a DRAM controller according to a fifth embodiment of the present invention;

FIG. 16 is a diagram for schematically explaining the operation according to the fifth embodiment;

FIG. 17 is a diagram for explaining a functional configuration of a DRAM controller according to a sixth embodiment of the present invention; and

FIG. 18 is a diagram for explaining the operation of a parity calculating and comparing unit according to the sixth embodiment.

### DETAILED DESCRIPTION OF THE INVENTION

Exemplary embodiments of a memory system, a transfer controller, and a memory control method according to the present invention will be explained below in detail with reference to the accompanying drawings. The present invention is not limited to the following embodiments.

### First Embodiment

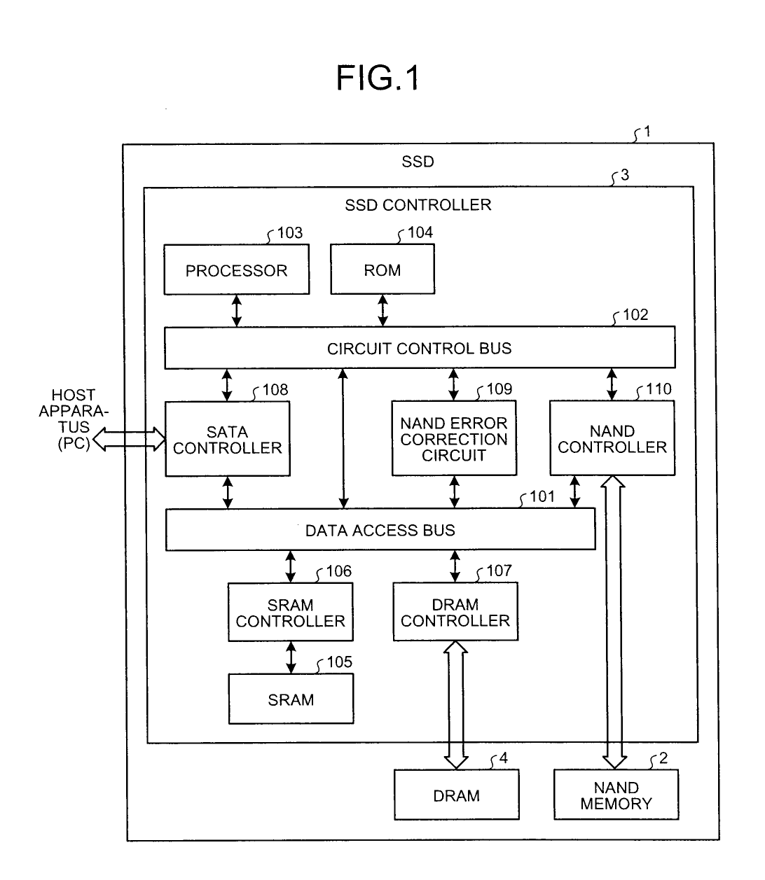

FIG. 1 is a block diagram of a configuration example of a solid state drive (SSD). As shown in the figure, an SSD 1 is connected to a host apparatus such as a personal computer according to a communication standard such as a serial ATA (SATA) interface and functions as an external memory for the host apparatus. The SSD 1 includes a NAND memory 2 as a nonvolatile memory that stores data write-requested by the host apparatus, an SSD controller 3 as a transfer controller that controls data transfer between the host apparatus and the NAND memory 2, and a dynamic random access memory (DRAM) 4 as a volatile memory used as a buffer area for data transfer by the SSD controller 3.

The SSD controller 3 includes a data access bus 101 and a circuit control bus 102. A processor 103 that controls the entire SSD controller 3 is connected to the circuit control bus 102. A read only memory (ROM) 104 having stored therein a boot program for booting management programs (firmware) stored in the NAND memory 2 is also connected to the circuit control bus 102.

A static random access memory (SRAM) 105 used as a data work area and a firmware expansion area is connected to the data access bus 101 via an SRAM controller 106. During starting, the firmware stored in the NAND memory 2 is transferred to the SRAM 105 and expanded by the boot program stored in the ROM 104. The processor 103 executes the firmware expanded in the SRAM 105 to thereby control the entire SSD controller 3.

A DRAM controller 107 that executes read and write control for the DRAM 4 is also connected to the data access bus 101. The DRAM controller 107 detects errors that occur before and after a series of DRAM access for writing transfer data in the DRAM 4 and reading out the written transfer data and disables an area where errors frequently occur during access. Functions of the DRAM controller 107 are explained in detail later.

A SATA interface controller (a SATA controller) 108, a NAND error correction circuit 109, and a NAND controller 110 are connected to both the data access bus 101 and the circuit control bus 102. The SATA controller 108 transmits and receives data to and from the host apparatus via a SATA interface.

The NAND controller 110 has an interface function for the NAND memory 2 and an error correcting function for correcting an error that occurs during access to the NAND memory 2. The error correcting function of the NAND controller 110 is a function for performing encoding of a second error correction code and encoding and decoding of a first error correction code. The NAND error correction circuit 109 performs decoding of the second error correction code. The first error correction code and the second error correction code are, for example, a Hamming code, a Bose Chaudhuri Hocqenghem (BCH) code, a Reed Salomon (RS) code, or a low density parity check (LDPC) code. A correction ability of the second error correction code is higher than that of the first error correction code.

A data flow between the host apparatus and the NAND memory 2 in the SSD 1 configured as explained above is explained. Data transmitted from the host apparatus and written in the NAND memory 2 is referred to as Write data. Data read out from the NAND memory 2 and transferred to the host apparatus is referred to as Read data.

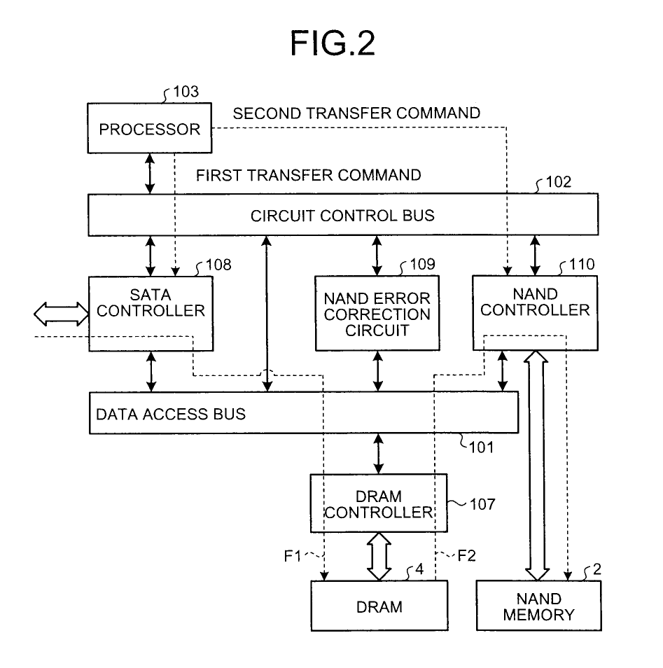

FIG. 2 is a diagram for explaining an example of a data flow until Write data transmitted from the host apparatus is written in the NAND memory 2. In FIG. 2, when the SATA controller 108 receives the Write data, the processor 103 issues a first transfer command for writing the Write data in the DRAM 2 to the SATA controller 108. The SATA controller 108 writes the Write data in the DRAM 4 based on the first transfer command (data flow F1).

The processor 103 issues, to the NAND controller 110, a second transfer command for reading out the Write data written in the DRAM 4 and writing the Write data in the NAND memory 2. The NAND controller 110 reads out, based on the second transfer command, the Write data written in the DRAM 4 and writes the Write data in the NAND memory 2 (data flow F2). In writing the Write data, the NAND controller 110 applies encoding of the second error correction code and the first error correction code to the Write data and writes the Write data in the NAND memory 2 together with the first and second error correction codes.

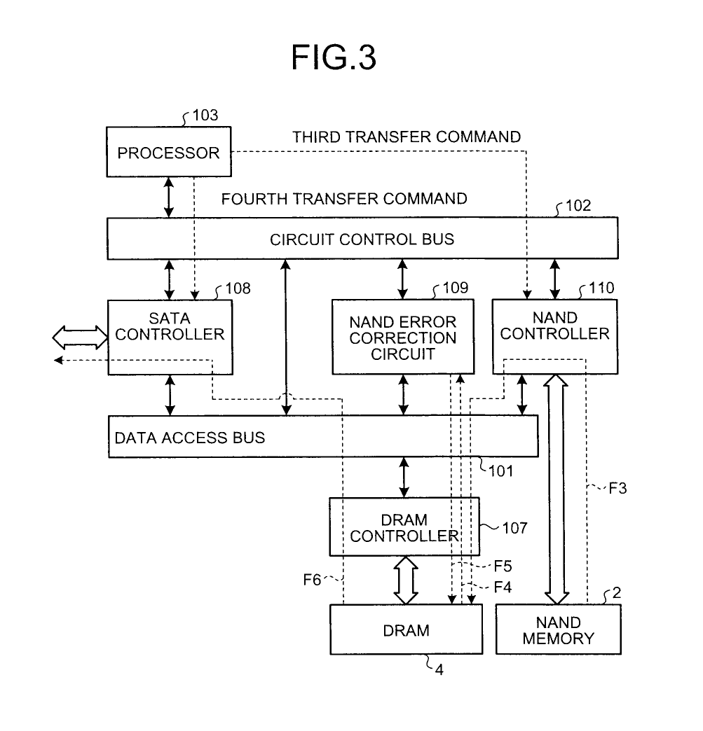

FIG. 3 is a diagram for explaining an example of a data flow until data written in the NAND memory 2 is read out and transferred to the host apparatus. The processor 103 issues, to the NAND controller 110, a third transfer command for reading out Read data from the NAND memory 2 and writing the read-out Read data in the DRAM 4 designating a writing destination address of the DRAM 4. The NAND controller 110 writes the Read data in the DRAM 4 based on the third transfer command (data flow F3). In writing the Read data, the NAND controller 110 performs decoding of the first error correction code and executes error detection and correction for the Read data read out from the NAND memory 2.

When the NAND controller 110 fails in the correction of an error in a process for executing the third transfer command, the NAND controller 110 notifies the processor 103 that the NAND controller 110 fails in the error correction. The processor 103 receives the notification and issues an error correction command to the NAND error correction circuit 109. The NAND error correction circuit 109 reads out, based on the error correction command from the processor 103, the Read data written in the DRAM 4 in the data flow F3 (data flow F4). The NAND error correction circuit 109 applies decoding of the second error correction code to the read-out Read data, executes error detection and correction, and writes the Read data subjected to the error detection and correction in the DRAM 4 again (data flow F5).

The processor 103 issues, to the SATA controller 108, a fourth transfer command for reading out the Read data and transferring the Read data to the host apparatus. The SATA controller 108 reads out, based on the fourth transfer command, the Read data subjected to the error correction by the NAND error correction circuit 109 and written in the DRAM 4 and transfers the Read data to the host apparatus (data flow F6).

When the NAND controller 110 succeeds in the error detection and correction in a process for executing the third transfer command, the NAND error correction circuit 109 does not execute the error correction. In this case, the SATA controller 108 reads out, based on the fourth transfer command, the Read data written in the DRAM 4 in the data flow F3 and transfers the Read data to the host apparatus (data flow F6).

In the first to fourth transfer commands and the error correction command issued by the processor 103, addresses of access destinations in the DRAM 4 are designated. Components at access sources (the SATA controller 108, the NAND error correction circuit 109, and the NAND controller 110) write data in and read out data from the addresses at the access destinations designated in the commands.

When the data is written in the DRAM 4 in the data flows F1, F3, and F5, the DRAM controller 107 applies parity calculation to the data to be written. When the data is read out from the DRAM 4 in the data flows F2, F4, and F6, the DRAM controller 107 applies parity calculation to the read-out data. The DRAM controller 107 compares results of the parity calculations during the data writing and during the data readout to thereby detect errors (parity errors) that occur before and after a series of operation for writing the data in the DRAM 4 and reading out the written data.

When the DRAM controller 107 detects an error, the DRAM controller 107 notifies the processor 103 that the error is detected. The processor 103 receives the error detection notification and determines in which data the error is detected. When the error is detected in the Write data read out from the DRAM 4 in the data flow F2, the processor 103 requests the SATA controller 108 to transmit the Write data again. When the error is detected in the Read data read out from the DRAM 4 in the data flow F6, the processor 103 requests the NAND controller 110 to transmit the Read data again. When the error is detected in the Read data read out from the DRAM 4 in the data flow F4, the processor 103 can request the NAND controller 110 to retransmit the Read data or can cause, without requesting the retransmission of the Read data, the NAND error correction circuit 109 to correct the data in which the error is detected.

Further, the DRAM controller 107 counts the number of times of accumulation of parity errors detected in each of divided areas formed by dividing a storage area of the DRAM 4 into a plurality of areas. When there is a divided area in which a count value exceeds a predetermined number of times, the DRAM controller 107 notifies the processor 103 that the divided area is disabled. The processor 103 receives the disable notification and does not designate the disabled area as a writing destination in the first and third transfer command. In short, in a divided area in which errors frequently occur, a count value exceeds the predetermined number of times. The divided area is set in a disabled state.

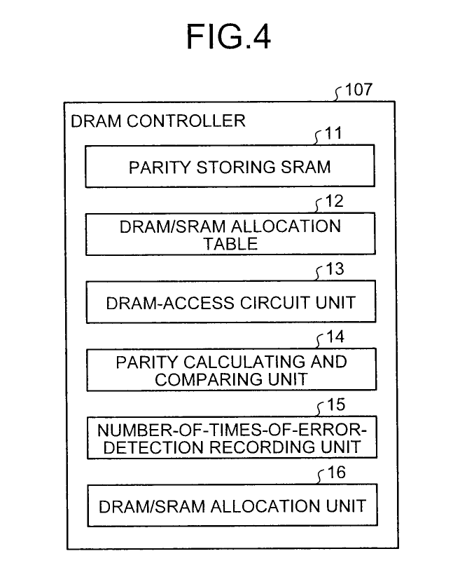

FIG. 4 is a diagram for explaining a functional configuration of the DRAM controller 107. As shown in the figure, the DRAM controller 107 includes a parity storing SRAM 11, a DRAM/SRAM allocation table 12, a DRAM-access circuit unit 13, a parity calculating and comparing unit 14, a number-of-times-of-error-detection recording unit 15, and a DRAM/SRAM allocation unit 16.

The parity storing SRAM 11 is a volatile memory as temporary storage means that temporarily stores a parity calculation result calculated for each data of a predetermined size. The size of an execution unit of parity calculation is hereinafter referred to as a parity calculation unit.

The DRAM/SRAM allocation table 12 is a table for managing, for each parity calculation unit, correspondence between an address of data written in the DRAM 4 and an address in the parity storing SRAM 11 in which a parity calculation result concerning the data is stored.

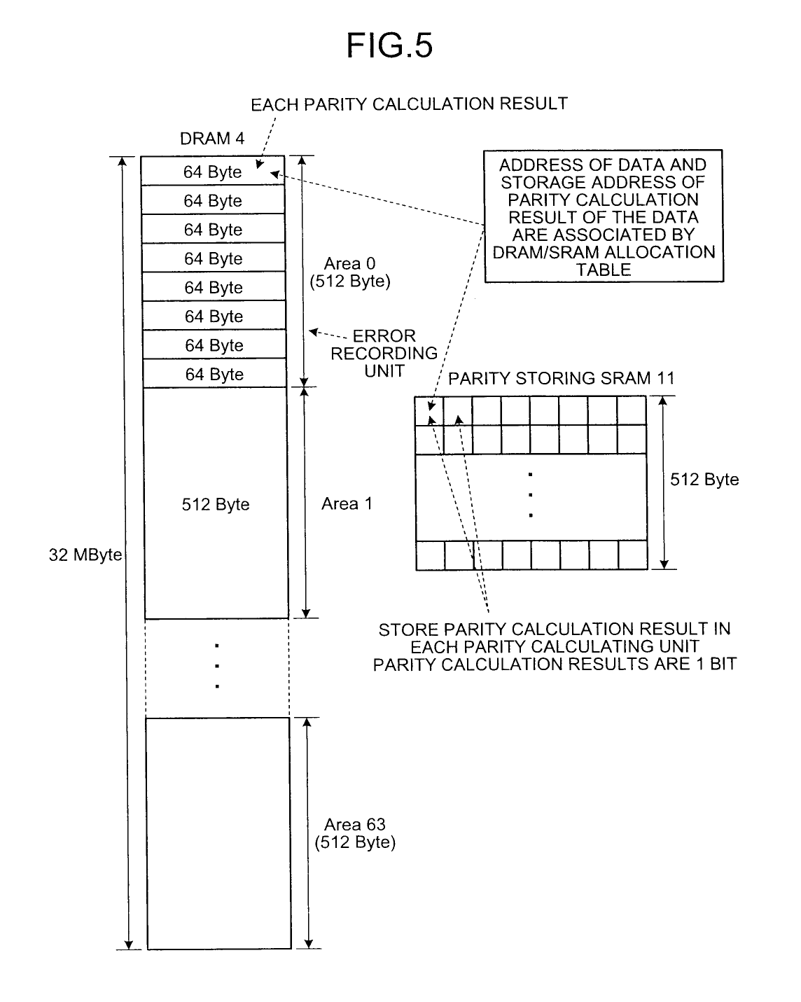

FIG. 5 is a diagram for explaining an example of a method of managing a parity calculation result. As shown in the figure, the DRAM 4 having a capacity of 32 megabytes is divided into sixty four divided areas, each having a capacity of an error recording unit (512 bytes). The divided areas are hereinafter simply represented as Areas. An x-th Area from the top of the DRAM 4 is represented as Area x. Each of the Areas can store eight data in a parity calculation unit (64 bytes). The parity storing SRAM 11 stores a parity calculation result of data for every 64 bytes. The DRAM/SRAM allocation table 12 associates an address of data in each parity calculation unit stored in the DRAM 4 and an address of a parity calculation result of the data stored in the parity storing SRAM 11. The size of each parity calculation result is 1 bit. Therefore, as shown in the figure, a capacity of the parity storing SRAM 11 is 512 bytes to correspond to the DRAM 4 having a capacity that can store 32-megabyte data in total.

Referring back to FIG. 4, the DRAM-access circuit unit 13 executes operation for writing data received from an access source (the SATA controller 108, the NAND error correction circuit 109, or the NAND controller 110) in the DRAM 4 and operation for reading out data from the DRAM 4 and transmitting the data to the access source.

The parity calculating and comparing unit 14 and the number-of-times-of-error-detection recording unit 15 function as error counting means for detecting, for each of the Areas, a parity error in inputting data to and outputting data from the Area and cumulatively counting the number of times of detection of the parity error.

Specifically, every time the DRAM-access circuit unit 13 receives data from an access destination in the parity calculation unit, the parity calculating and comparing unit 14 calculates a parity for the received data in the parity calculation unit before being written in the DRAM 4. The parity calculating and comparing unit 14 calculates, referring to the DRAM/SRAM allocation table 12, an address of the parity storing SRAM 11, in which a parity calculation result is stored, corresponding to an address of the DRAM 4 at a writing destination of the received data in the parity calculation unit. The parity calculating and comparing unit 14 stores a parity calculation result of the data in the calculated address of the parity storing SRAM 11. The parity calculating and comparing unit 14 executes, every time the DRAM-access circuit unit 13 reads out data in the parity calculation unit from the DRAM 4, parity calculation on the read-out data in the parity calculation unit. The parity calculating and comparing unit 14 calculates, referring to the DRAM/SRAM allocation table 12, an address on the parity storing SRAM 11, in which a parity calculation result is stored, corresponding to an address on the DRAM 4 in which the read-out data in the parity calculation unit is written. The parity calculating and comparing unit 14 reads out a parity calculation result during writing of the data from the calculated address and compares the parity calculation result with a parity calculation result obtained when the data is read out. When the parity calculation results are different, the parity calculating and comparing unit 14 notifies the number-of-times-of-error-detection recording unit 15 and the processor 103 that an error is detected.

The number-of-times-of-error-detection recording unit 15 counts, for each of the Areas, the error detection notification received from the parity calculating and comparing unit 14 and records a count value of the error detection notification. In other words, the number-of-times-of-error-detection recording unit 15 counts, for each of the Areas, the number of times of occurrence of a parity error and records a cumulative result of the parity error.

The DRAM/SRAM allocation unit 16 and the processor 103 function as allocation control means for setting an Area in which a count value exceeds a predetermined number of times in the disabled state. Specifically, when there is an Area in which a count value of error detection recorded by the number-of-times-of-error-detection recording unit 15 exceeds a predetermined number of times set by the processor 103 (firmware) or the like, the DRAM/SRAM allocation unit 16 issues disable notification for disabling the Area to the processor 103. The processor 103 receives the disable notification and disables the Area.

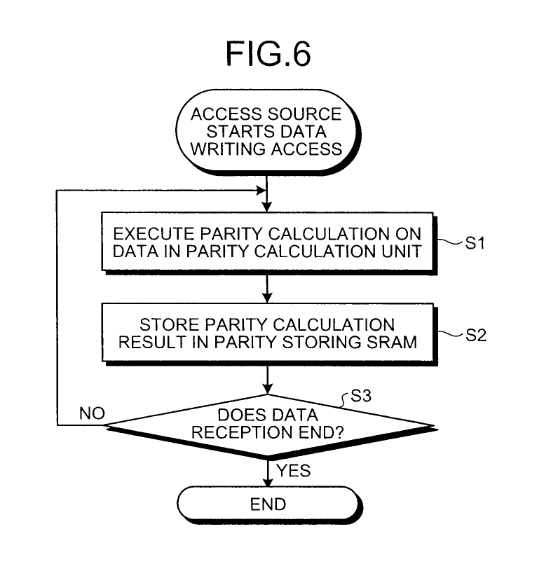

FIG. 6 is a flowchart for explaining the operation performed by the DRAM controller 107 when an access source writes data in the DRAM 4.

In FIG. 6, first, the access source transmits an address of a writing destination, a request signal for writing data, and the data to the DRAM controller 107. For example, the access source transmits 512-byte data to an Area 0 set as the writing destination.

The DRAM-access circuit unit 13 receives data and writes the data in the Area 0. The parity calculating and comparing unit 14 calculates, every time the DRAM-access circuit unit 13 receives the data by 64 bytes, a parity for the received 64-byte data (step S1). The parity calculating and comparing unit 14 stores, based on the DRAM/SRAM allocation table 12, a parity calculation result in the parity storing SRAM 11 (step S2).

The parity calculating and comparing unit 14 determines whether the data reception from the access source ends (step S3). When the data reception does not end (“No” at step S3), the parity calculating and comparing unit 14 shifts to step S1. When the data reception ends (“Yes” at step S3), i.e., when all the 512-byte data write-requested by the access source are received, the parity calculating and comparing unit 14 ends the operation. According to the operation, eight parity calculation results are calculated from the data stored in the Area 0 and are stored in the parity storing SRAM 11.

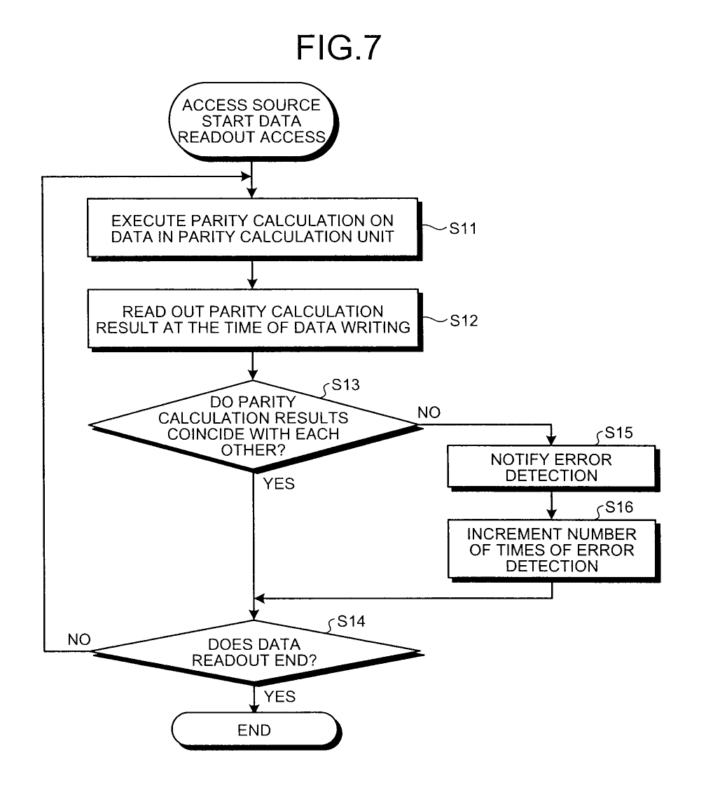

FIG. 7 is a flowchart for explaining the operation performed by the DRAM controller 107 when an access source reads out data from the DRAM 4. First, access source transmits an address of a readout destination and a request signal for reading out data to the DRAM controller 107. For example, the access source reads out 512-byte data with the Area 0 set as the readout destination.

The DRAM-access circuit unit 13 reads out data from the Area 0 and transmits the read-out data to the access source. The parity calculating and comparing unit 14 calculates, every time the DRAM-access circuit unit 13 reads out the data by 64 bytes, a parity for the read-out 64-byte data (step S11). The parity calculating and comparing unit 14 reads out the parity calculation result of the data stored in the parity storing SRAM 11 at step S2 (step S12). The parity calculating and comparing unit 14 compares the read-out parity calculation result and a parity calculation result calculated at step S11 and determines whether the parity calculation results coincide with each other (step S13). When the parity calculation results coincide with each other (“Yes” at step S13), the parity calculating and comparing unit 14 determines that an error is not detected and further determines whether the readout of data transmitted to the access source is completed (step S14). When the readout of data is completed (“Yes” at step S14), the parity calculating and comparing unit 14 ends the operation. When the readout of data is not completed (“No” at step S14), the parity calculating and comparing unit 14 shifts to step S11.

When the parity calculation results do not coincide with each other at step S13 (“No” at step S13), the parity calculating and comparing unit 14 determines that an error is detected and notifies the processor 103 and the number-of-times-of-error-detection recording unit 15 that the error is detected (step S15). The number-of-times-of-error-detection recording unit 15 increments a count value for recording the number of times of error detection in the Area 0 (step S16) and shifts to step S14.

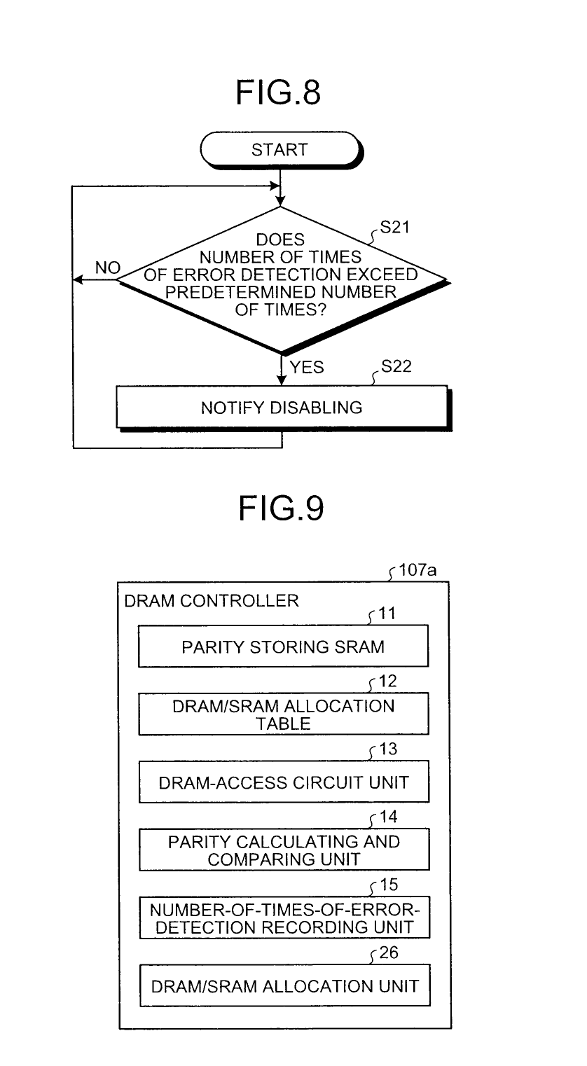

FIG. 8 is a flowchart for explaining the operation of the DRAM/SRAM allocation unit 16 for notifying the processor 103 of disabling of an Area. As shown in FIG. 8, the DRAM/SRAM allocation unit 16 monitors a count value of the number of times of error detection for each of the Areas and determines, for each of the Areas, whether the count value exceeds a predetermined number of times (step S21). When there is no Area in which the count value exceeds the predetermined number of times (“No” at step S21), the DRAM/SRAM allocation unit 16 continues the monitoring of the count value and executes an infinite loop until the count value exceeds the predetermined number of times. When there is an area in which the count value exceeds the predetermined number of times (“Yes” at step S21), the DRAM/SRAM allocation unit 16 leaves the infinite loop and notifies the processor 103 that the area in which the count value exceeds the predetermined number of times is disabled (step S22).

In the above explanation, the number of times of error detection is counted for each of the Areas and, when the count value exceeds the predetermined number of times, the disable notification for disabling the area in which the count value exceeds the predetermined number of times is issued. However, it is also possible to periodically reset the count value for each of the Areas to thereby substantially record an error detection frequency and issue disable notification for disabling an Area in which the error detection frequency exceeds a reference set by firmware or the like.

The functional components of the DRAM controller 107 do not need to be realized in the DRAM controller 107. A part or all of the functional components can be realized in other components of the SSD 1 such as the processor 103. In the above explanation, the parity storing SRAM 11 is used as the area for storing a parity. However, a parity can be stored in other memories.

In the above explanation, the DRAM controller 107 notifies the processor 103 of the disabling of an Area and the processor 103 does not designate the notified Area as a writing destination to thereby disable the Area. However, instead of notifying the processor 103 of the disabling an Area, the DRAM controller 107 can change, when access with a writing destination set in an Area in which the number of times of error detection exceeds the predetermined number of times is received, the writing destination to another Area in the DRAM 4 to thereby substantially disable the area in which the number of times of error detection exceeds the predetermined number of times.

In the above explanation, the DRAM 4 is used as a buffer area for data transfer. However, the DRAM 4 can be used as a cache area.

As explained above, according to the first embodiment, the SSD controller 2 calculates, for each of the Areas formed by dividing the storage area of the DRAM 4 into a plurality of areas, a parity error in inputting data to and outputting data from the Areas, counts the number of times of parity error accumulation, and disables an Area in which the number of times of parity error accumulation exceeds the predetermined number of times. This makes it possible to obtain a memory system in which a frequency of occurrence of an error during DRAM access is reduced as much as possible.

### Second Embodiment

According to the first embodiment, when a designer or the like changes the capacity of the DRAM 4, the designer has to change hardware design including a change of a capacity of the parity storing SRAM 11 according to the change of the capacity of the DRAM 4. Therefore, a second embodiment of the present invention allows, by making a parity calculation unit variable, the designer to cope with the change of the capacity of the DRAM 4 without changing the parity storing SRAM 11.

FIG. 9 is a diagram for explaining a functional configuration of a DRAM controller according to the second embodiment. In the following explanation, components having functions same as those in the first embodiment are denoted by the same reference numerals and signs and detailed explanation of the components is omitted.

As shown in FIG. 9, a DRAM controller 107a according to the second embodiment includes the parity calculating and comparing unit 14, the number-of-times-of-error-detection recording unit 15, the DRAM/SRAM allocation table 12, the parity storing SRAM 11, the DRAM-access circuit unit 13, and a DRAM/SRAM allocation unit 26.

The DRAM/SRAM allocation unit 26 changes a parity calculation unit based on input from the processor 103 (firmware). Specifically, the DRAM/SRAM allocation unit 26 changes association of an address for storing data in the DRAM 4 and an address for storing a parity calculation result of the DRAM/SRAM allocation table 13 to thereby change the parity calculation unit.

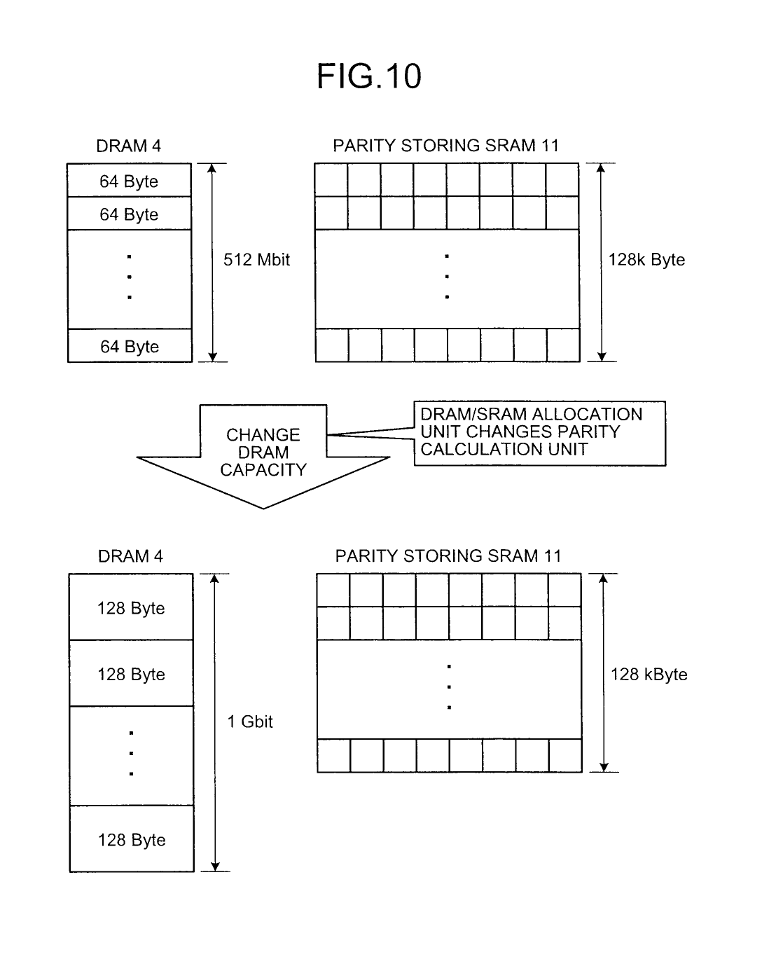

FIG. 10 is a diagram for explaining a change of the capacity of the DRAM 4 from 512 megabits to 1 gigabit. As shown in the figure, according to the design before the change of the capacity of the DRAM 4, the parity calculation unit is 64 bytes and the parity storing SRAM 11 has a capacity of 128 bytes according to the capacity of the DRAM 4 and the parity calculation unit. When the designer changes the capacity of the DRAM 4 to 1 gigabit twice as large as the capacity before the change, in the past, the capacity of the parity storing SRAM 11 needs to be also changed to 256 bytes twice as large as 128 bytes. According to this embodiment, the firmware changes the parity calculation unit to 128 bytes twice as large as that before the change. This makes it possible to avoid the necessity of changing a necessary capacity of the parity storing SRAM 11. When the parity calculation unit is set large, although there is a demerit that accuracy of error detection falls, it is possible to avoid the necessity of changing the capacity of the parity storing SRAM 11 according to the change of the capacity of the DRAM 4. This makes it possible to reduce cost and time for designing hardware anew to change the capacity of the DRAM 4.

As explained above, according to the second embodiment, because the parity calculation unit can be changed, it is possible to change the capacity of the DRAM 4 without changing the capacity of a parity storage area.

### Third Embodiment

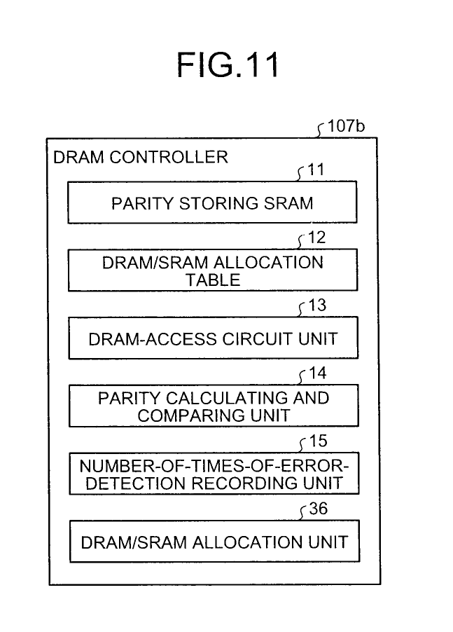

A SSD according to a third embodiment of the present invention can allocate, when a certain Area is disabled, a storage area in the parity storing SRAM 11, in which a parity calculation result of this Area is stored, to another Area. FIG. 11 is a diagram for explaining a functional configuration of a DRAM controller according to the third embodiment.

As shown in FIG. 11, a DRAM controller 107b according to the third embodiment includes the parity storing SRAM 11, the DRAM/SRAM allocation table 12, the DRAM-access circuit unit 13, the parity calculating and comparing unit 14, the number-of-times-of-error-detection recording unit 15, and a DRAM/SRAM allocation unit 36.

The DRAM/SRAM allocation unit 36 allocates, when a certain Area in the DRAM 4 is disabled, a storage area of the parity storing SRAM 11, to which this area is allocated, to an area in which a parity calculation result is stored of another Area not disabled. The DRAM/SRAM allocation unit 36 changes a parity calculation unit of the new allocated Area to be smaller. The DRAM/SRAM allocation unit 36 corrects the DRAM/SRAM allocation table 12 and reflects the allocation of the Area and the change of the parity calculation unit on the DRAM/SRAM allocation table 12.

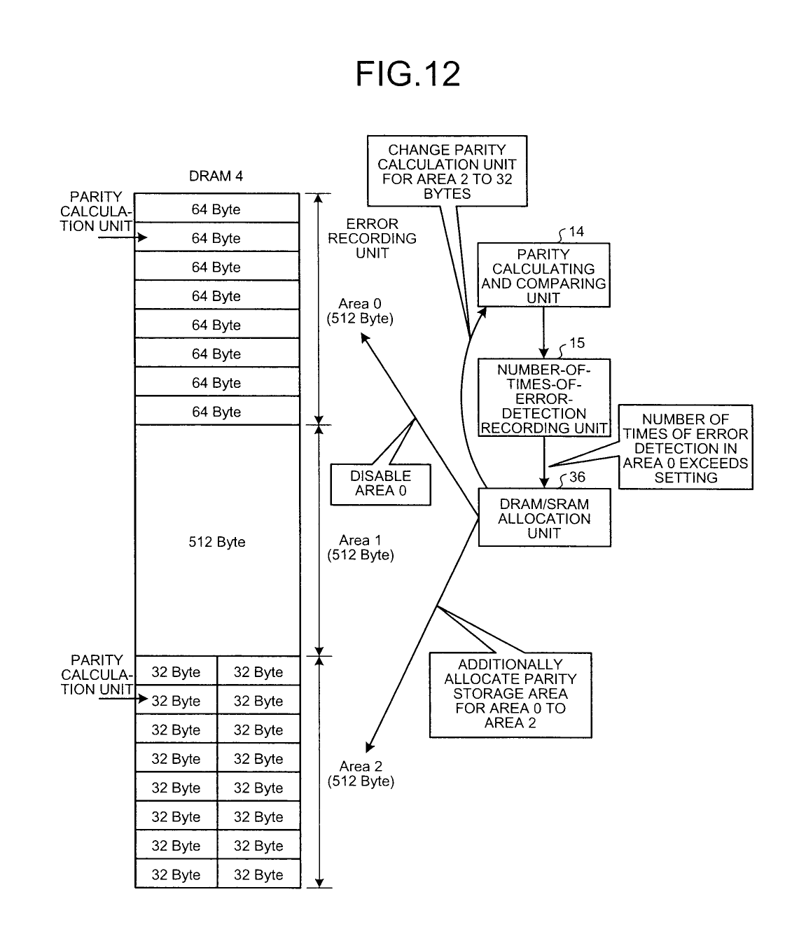

FIG. 12 is a diagram for schematically explaining an example of the operation of the DRAM controller 107b. In FIG. 12, when the number of times of error detection in the Area 0 exceeds the predetermined number of times and the DRAM/SRAM allocation unit 36 disables an Area 1, the DRAM/SRAM allocation unit 36 allocates an area for 8 bits of the parity storing SRAM 11, which is allocated to the Area 0, to an Area 2. As a result, an area for storing a parity calculation result allocated to the Area 2 increases from 8 bits to 16 bits. Therefore, the DRAM/SRAM allocation unit 36 changes a parity calculation unit for the Area 2 from 64 bytes to finer 32 bytes. Because the parity calculation unit for the Area 2 is set finer, error detection accuracy for data written in the Area 2 is improved compared with that before the change.

As explained above, according to the third embodiment, an area of the parity storing SRAM 11, in which the parity of data is stored, of the disabled Area is allocated to an area for storing the parity of data of another Area. A parity calculation unit of the data of the other Area is set finer. This makes it possible to efficiently use the parity storing SRAM 11.

### Fourth Embodiment

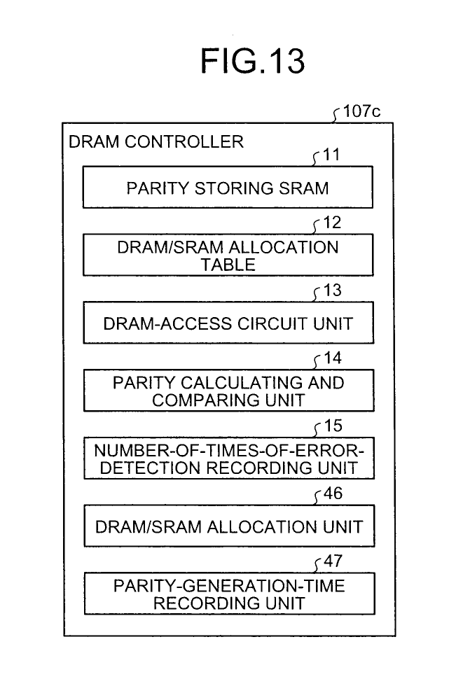

According to a fourth embodiment of the present invention, parity calculation results are deleted or invalidated in order from oldest one to save the capacity of the parity storing SRAM 11. FIG. 13 is a diagram for explaining a configuration of a DRAM controller according to the fourth embodiment.

In FIG. 13, a DRAM controller 107c according to the fourth embodiment includes the parity storing SRAM 11, the DRAM/SRAM allocation table 12, the DRAM-access circuit unit 13, the parity calculating and comparing unit 14, the number-of-times-of-error-detection recording unit 15, a DRAM/SRAM allocation unit 46, and a parity-generation-time recording unit 47.

The parity-generation-time recording unit 47 records time when a parity calculation result is stored in the parity storing SRAM 11.

The DRAM/SRAM allocation unit 46 deletes or invalidates, referring to parity storage time recorded by the parity-storage-time recording unit 47, a parity calculation result stored exceeding a term of validity set by firmware or the like. The DRAM/SRAM allocation unit 46 allocates anew an area in which the deleted or invalidated parity calculation result is stored as an area for storing or overwriting a parity calculation result of another data. The DRAM/SRAM allocation unit 46 corrects the DRAM/SRAM allocation table 12 to thereby reflect the new allocation thereon.

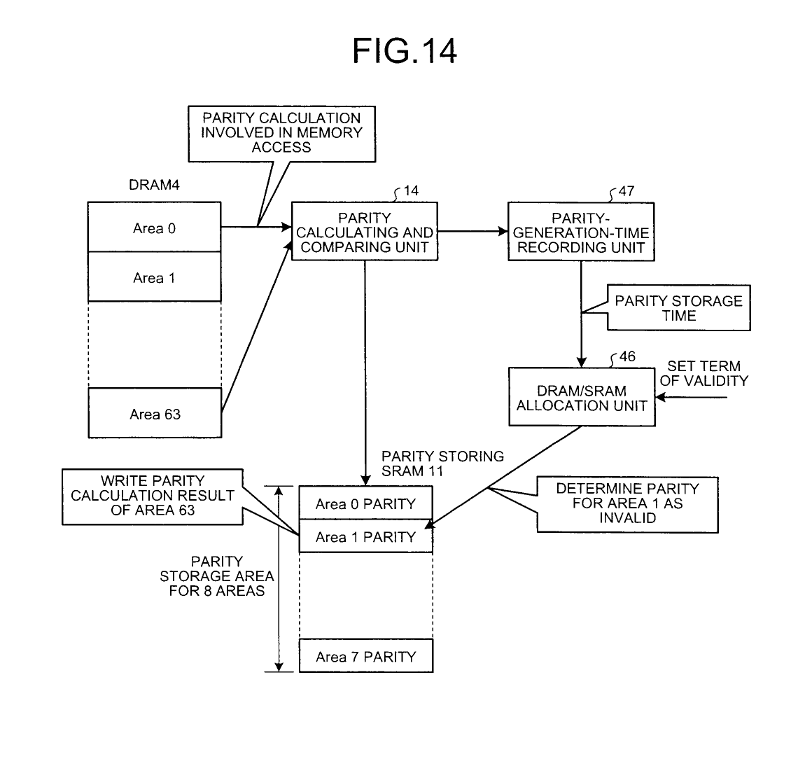

FIG. 14 is a diagram for schematically explaining an example of the operation of the DRAM controller 107c according to the fourth embodiment. In the example shown in FIG. 14, parity storage time is recorded for each of Areas. The deletion of a parity calculation result and the allocation of a deleted area are performed in Area units. The DRAM 4 has sixty-four Areas in total: an Area 0 to an Area 63. The parity storing SRAM 11 has the size for storing parity calculation results for eight Areas. Area for storing parity calculation results of the Area 0 to the Area 7 are already allocated to the parity storing SRAM 11. When elapsed time from parity storage time of the Area 1 exceeds the term of validity, the DRAM/SRAM allocation unit 46 deletes the parity calculation result of the Area 1 and allocates an area in which the deleted parity calculation result is stored as, for example, a storage area for a parity calculation result of the Area 63.

As explained above, according to the fourth embodiment, because old parity calculation results are deleted, the number of parity calculation results stored in the parity storing SRAM 11 can be reduced. This makes it possible to reduce the capacity of the parity storing SRAM 11.

In the above explanation, a parity calculation result stored exceeding the term of validity is deleted and the area from which the parity calculation result is deleted is allocated as a storage area for a parity calculation result of another data. However, when a new parity calculation result needs to be stored, a parity calculation result stored at earliest time can be deleted to allocate an area from which the parity calculation result is deleted as an area for storing the new parity calculation result. A parity calculation result read out at earliest time rather than stored at earliest time can be deleted.

### Fifth Embodiment

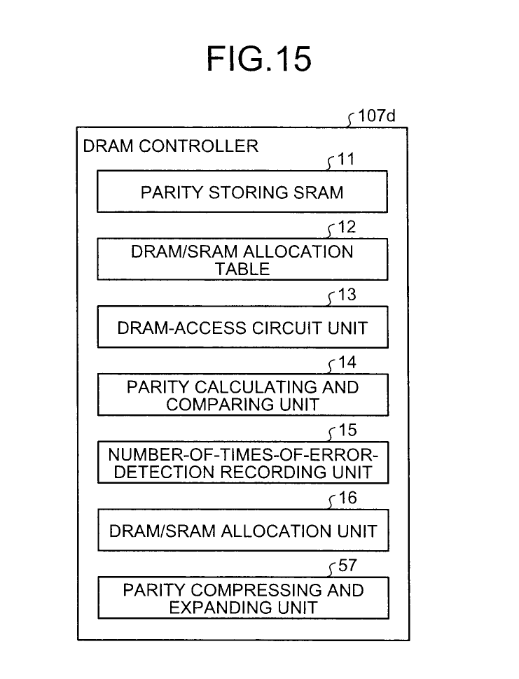

According to a fifth embodiment of the resent invention, a parity storing SRAM compresses and stores parity calculation results. FIG. 15 is a diagram for explaining a configuration of a DRAM controller according to the fifth embodiment.

As shown in FIG. 15 a DRAM controller 107d according to the fifth embodiment includes the parity storing SRAM 11, the DRAM/SRAM allocation table 12, the DRAM-access circuit 13, the parity calculating and comparing unit 14, the number-of-times-of-error-detection recording unit 15, the DRAM/SRAM allocation unit 16, and a parity compressing and expanding unit 57.

The parity compressing and expanding unit 57 collects a plurality of parity calculation results calculated by the parity calculating and comparing unit 14, compresses the parity calculation results with a reversible code such as a Huffman code, and stores the parity calculation results in the parity storing SRAM 11. The parity compressing and expanding unit 57 reads out parity calculation results compressed and stored in the parity storing SRAM 11, expands the read-out parity calculation results, and passes the parity calculation results to the parity calculating and comparing unit 14.

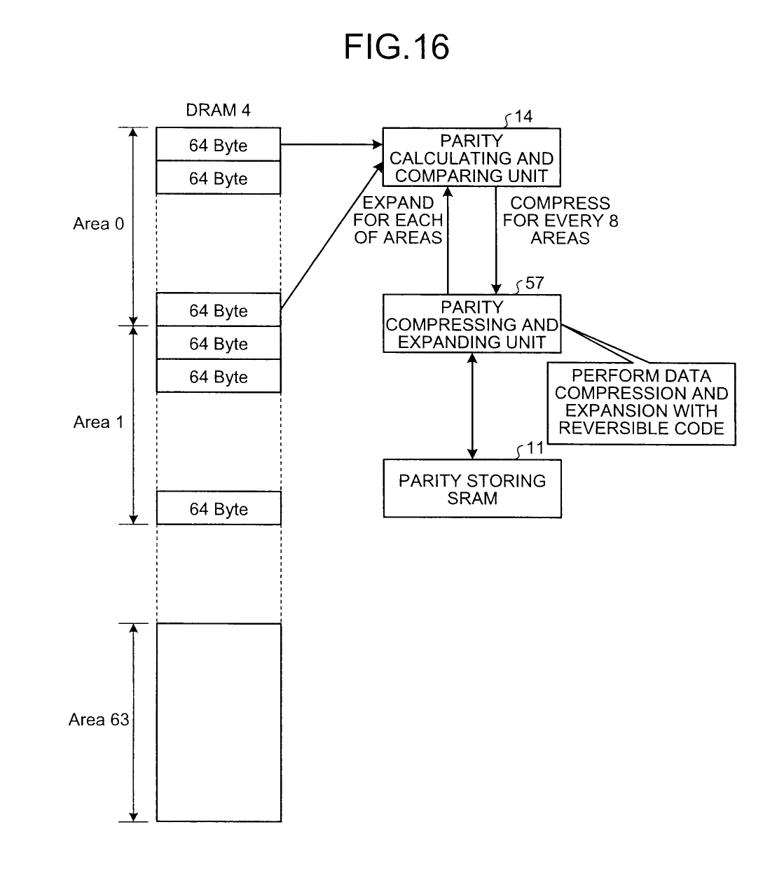

FIG. 16 is a diagram for schematically explaining an example of the operation of the DRAM controller 107d. In the example shown in FIG. 16, a parity calculation unit is set to 64 bytes and an error recording unit is set to 512 bytes. The parity compressing and expanding unit 57 compresses parity calculation results for the error recording unit, i.e., eight parity calculation results and stores the parity calculation results in the parity storing SRAM 11. The parity compressing and expanding unit 57 reads out expands the compressed eight parity calculation results and passes the expanded eight parity calculation results to the parity calculating and comparing unit 14.

As explained above, according to the fifth embodiment, parity calculation results of data stored in the DRAM 4 are compressed and stored. This makes it possible to save the capacity of the parity storing SRAM 11.

### Sixth Embodiment

With SSDs according to the first to fifth embodiments, even when data written in a DRAM is rewritten by 1 bit, it is necessary to read out data for the parity calculation unit and executes parity calculation on the read-out data for the parity calculation unit again. On the other hand, when data written in a DRAM is rewritten by the size equal to or smaller than a parity calculation unit, an SSD according to a sixth embodiment of the present invention changes, based on a change of a rewritten section, a parity calculation result stored in a parity storing SRAM.

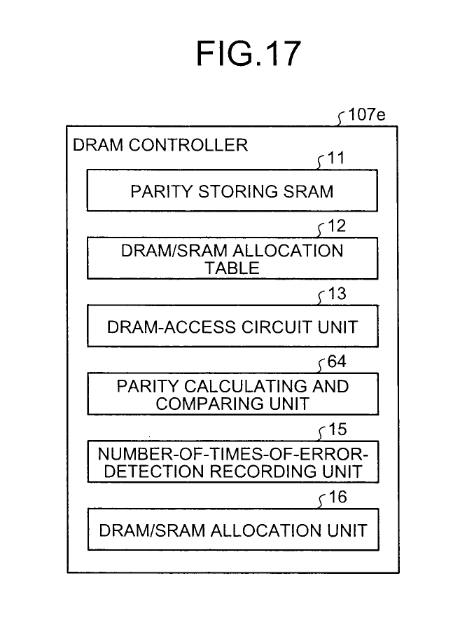

FIG. 17 is a block diagram for explaining a functional configuration of a DRAM controller according to the sixth embodiment. As shown in the figure, a DRAM controller 107e according to the sixth embodiment includes the parity storing SRAM 11, the DRAM/SRAM allocation table 12, the DRAM-access circuit unit 13, a parity calculating and comparing unit 64, the number-of-times-of-error-detection recording unit 15, and the DRAM/SRAM allocation unit 16.

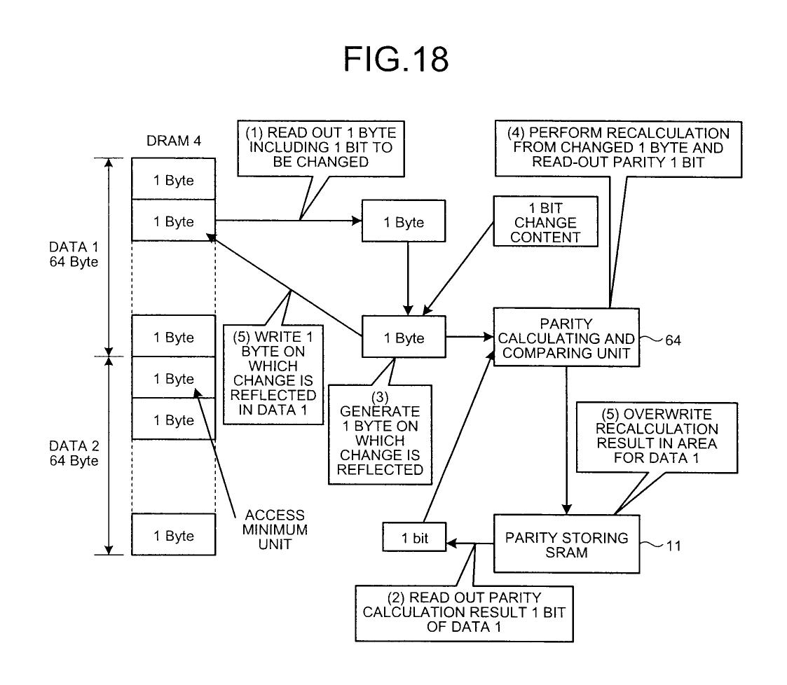

FIG. 18 is a diagram for explaining the operation of the parity calculating and comparing unit 64. In FIG. 18, a parity calculation unit is set to 64 bytes and an access unit for access to the DRAM 4 is set to 1 byte. First, when a request for rewriting 1 bit of a second byte section from the top of data 1 having the size of the parity calculation unit is received from an access source, the parity calculating and comparing unit 64 reads out 1-byte data including the 1-bit rewritten section ((1) in the figure). The parity calculating and comparing unit 64 reads out a parity calculation result of the data 1 from the parity storing SRAM 11 ((2) in the figure).

Subsequently, the parity calculating and comparing unit 64 reflects the 1-bit rewriting request from the access source on the read-out 1-byte data including the 1-bit rewritten section and generates 1-byte data anew ((3) in the figure). The parity calculating and comparing unit 64 recalculates a parity from the read-out parity calculation result and the number of bits of content requested to be rewritten ((4) in the figure). When the size of the written section is odd number bits, the parity calculating and comparing unit 64 reverses the parity. When the size of the written section is even number bits, the parity calculating and comparing unit 64 does not reverse the parity. Because the content to be changed is only 1 bit, the parity calculating and comparing unit 64 reverses the read-out parity calculation result. Finally, the parity calculating and comparing unit 64 overwrites the second byte section from the top of the data 1 stored in the DRAM 4 with the rewritten 1-byte data and overwrites the parity calculation result of the data 1 with a value obtained by the recalculation ((5) in the figure).

As explained above, according to the sixth embodiment, when, in data of the parity calculation unit stored in the DRAM 4, a part of the data having size smaller than the parity calculation unit is rewritten, the parity calculating and comparing unit 64 rewrites, based on a change between before and after the rewriting of this part of the data, the parity calculation result stored in the parity storing SRAM 11. Therefore, it is possible to avoid the necessity of reading out the data of the parity calculation unit and recalculate a parity to rewrite a part of data having size smaller than the parity calculation unit. This makes it possible to obtain a parity calculation result at high speed.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A memory system comprising:
a nonvolatile memory;
a volatile buffer memory connected to the nonvolatile memory;
an error counting unit that detects, for each of divided areas formed by dividing a storage area of the volatile buffer memory into a plurality of areas, a parity error in inputting data to and outputting data from the divided areas and counts a number of times of accumulation of the parity error; and
a control unit that sets the divided area, in which the number of times of accumulation of the parity error counted by the error counting unit exceeds a predetermined number of times, in a disabled state.

2. The memory system according to claim 1, wherein
the error counting unit includes:
a parity calculating and comparing unit that calculates, in each parity calculation unit smaller than a unit of the division, a parity before being written in the volatile buffer memory and a parity after being read out from the volatile buffer memory and compares the calculated parities; and
a number-of-times-of-error-detection recording unit that counts an accumulated number of times of a parity error in the divided areas by totaling, in the division unit, comparison results of the parity calculating and comparing unit, and
the memory system further includes a temporary storing unit that temporarily stores the calculated a parity before being written in the volatile buffer memory.

3. The memory system according to claim 2, further comprising an allocation table that associates, in each parity calculation unit, an address of data written in the volatile buffer memory and an address in the temporary storing unit that stores a parity concerning the data with each other and can change the association in each parity calculation unit.

4. The memory system according to claim 3, wherein the allocation control unit changes the allocation table to associate an address in the temporary storing unit, which is associated with an address of data written in the divided area set in the disabled state, with an address of data written in another divided area.

5. The memory system according to claim 2, further comprising a parity-generation-time recording unit that records time when a parity calculated by the parity calculating and comparing unit is stored in the temporary storing unit, wherein
the allocation control unit deletes, based on the time recorded by the parity-generation-time recording unit, parities stored by the temporary storing unit in order from oldest one.

6. The memory system according to claim 2, further comprising a parity compressing unit that compresses a plurality of parities calculated by the parity calculating and comparing unit, wherein
the temporary storing unit stores the parities compressed by the parity compressing unit.

7. The memory system according to claim 2, wherein, when, in data stored in the volatile buffer memory, a part of the data having size smaller than parity calculation size is rewritten, the parity calculating and comparing unit rewrites, based on a change between before and after the rewriting of the part of the data, a parity corresponding to the part of the data stored by the first storing unit.

8. A transfer controller that controls a nonvolatile memory and a volatile buffer memory connected to the nonvolatile memory, the transfer controller comprising:
an error counting unit that detects, for each of divided areas formed by dividing a storage area of the volatile buffer memory into a plurality of areas, a parity error in inputting data to and outputting data from the divided areas and counts a number of times of accumulation of the parity error; and
a control unit that sets the divided area, in which the number of times of accumulation of the parity error counted by the error counting unit exceeds a predetermined number of times, in a disabled state.

9. The transfer controller according to claim 8, wherein
the error counting unit includes:
a parity calculating and comparing unit that calculates, in each parity calculation unit smaller than a unit of the division, a parity before being written in the volatile buffer memory and a parity after being read out from the volatile buffer memory and compares the calculated parities; and
a number-of-times-of-error-detection recording unit that counts an accumulated number of times of a parity error in the divided areas by totaling, in the division unit, comparison results of the parity calculating and comparing unit, and
the transfer controller further includes a temporary storing unit that temporarily stores the calculated a parity before being written in the volatile buffer memory.

10. The transfer controller according to claim 9, further comprising an allocation table that associates, in each parity calculation unit, an address of data written in the volatile buffer memory and an address in the temporary storing unit that stores a parity concerning the data with each other and can change the association in each parity calculation unit.

11. The transfer controller according to claim 10, wherein the allocation control unit changes the allocation table to associate an address in the temporary storing unit, which is associated with an address of data written in the divided area set in the disabled state, with an address of data written in another divided area.

12. The transfer controller according to claim 9, further comprising a parity-generation-time recording unit that records time when a parity calculated by the parity calculating and comparing unit is stored in the temporary storing unit, wherein
the allocation control unit deletes, based on the time recorded by the parity-generation-time recording unit, parities stored by the temporary storing unit in order from oldest one.

13. The transfer controller according to claim 9, further comprising a parity compressing unit that compresses a plurality of parities calculated by the parity calculating and comparing unit, wherein
the temporary storing unit stores the parities compressed by the parity compressing unit.

14. The transfer controller according to claim 9, wherein, when, in data stored in the volatile buffer memory, a part of the data having size smaller than parity calculation size is rewritten, the parity calculating and comparing unit rewrites, based on a change between before and after the rewriting of the part of the data, a parity corresponding to the part of the data stored by the first storing unit.

15. A memory control method for controlling a nonvolatile memory and a volatile buffer memory connected to the nonvolatile memory, the memory control method comprising:
dividing a storage area of the volatile buffer memory into a plurality of areas;
detecting a parity error in inputting data to and outputting data from the divided areas;
counting a number of times of accumulation of the parity error; and
setting the divided area, in which the number of times of accumulation of the parity error exceeds a predetermined number of times, in a disabled state.

16. The memory control method according to claim 15, wherein
the detecting and counting includes:
calculating, in each parity calculation unit smaller than a unit of the division, a parity before being written in the volatile buffer memory and temporarily storing the parity;
calculating a parity after being read out from the volatile buffer memory and comparing the parity with the parity before being written in the volatile buffer memory; and
counting an accumulated number of times of a parity error in the divided areas by totaling, in the division unit, results of the comparison.

17. The memory control method according to claim 16, further associating, in each parity calculation unit, an address of data written in the volatile buffer memory and an address on the temporary storing unit in which a parity concerning the data is temporarily stored.

18. The memory control method according to claim 17, wherein the setting the divided area in the disabled state includes changing an address in the temporary storing unit, which is associated with an address of data written in the divided area set in the disabled state to an address of data written in another divided area.

19. The memory control method according to claim 16, further comprising deleting temporarily-stored parities before being written in the volatile buffer memory in order from oldest one.

20. The memory control method according to claim 16, further comprising compressing and storing the parity before being written in the volatile buffer memory.

21. The memory control method according to claim 16, wherein the detecting and counting includes, when, in data stored in the volatile buffer memory, a part of the data having size smaller than parity calculation size is rewritten, rewriting, based on a change between before and after the rewriting of the part of the data, the temporarily-stored parity corresponding to the part of the data.
